(19) United States
(12) Patent Application Publication
(10) Pub. No.: US 2014/0335306 A1
(43) Pub. Date: Nov. 13, 2014

(54) 3D Fiber Composite

(71) Applicant: Gosakan ARAVAMUDAN, (US)

(72) Inventor: Gosakan Aravamudan, Bangalore (IN)

(21) Appl. No.: 14/357,771

(22) PCT Filed: Dec. 11, 2012
(86) PCT No.: PCT/IN2012/000812

§ 371 Date: May 13, 2014

(30) Foreign Application Priority Data
Dec. 13, 2011 (IN) 4356/CHE/2011

(51) Int. Cl. B32B 3/12; B32B 37/24

(52) U.S. Cl. CPC B32B 3/12; B32B 37/24; B32B 2260/021; B32B 2307/56; B32B 2037/243
USPC 428/116; 156/62.8

(57) ABSTRACT

A composite having a core containing a cellular structure, reinforcing fibers, an upper face sheet, and a lower face sheet is provided. The cellular structure is a honeycomb structure containing strips of carrier material arranged in an x direction in an x-y plane, adhered together, and expanded in the x direction after adhesion. The reinforcing fibers are externally bonded onto the outer walls of each of the cells of the cellular structure in a z direction. The upper face sheet and the lower face sheet are configured to be bonded to the upper portion and the lower portion of the reinforcing fibers that extend outwardly from the upper edges and the lower edges of the cells of the cellular structure respectively, thereby establishing a three dimensional continuity of the reinforcing fibers between a surface of contact between the core, the upper face sheet, and the lower face sheet.

### CROSS REFERENCE TO RELATED APPLICATIONS

This application is a national phase application of PCT application number PCT/IN2012/000812 titled “3D Fiber Composite”, filed in the Indian Patent Office on Dec. 11, 2012, which claims priority to and the benefit of provisional patent application number 4356/CHE/2011 titled “3D Fiber Composite”, filed in the Indian Patent Office on Dec. 13, 2011. The specifications of the above referenced patent applications are incorporated herein by reference in their entirety.

### BACKGROUND

This invention, in general, relates to a composite structure. More particularly, the composite structure is relates to a composite with a honeycomb core structure with three dimensional fiber continuity.

Honey comb structures are most commonly used in applications where light weight materials are desirable, for example, in interiors of aircrafts, in paperboard honeycombs used in paper pallets, glass flooring systems, etc. Improvements in aerospace design, motor vehicle equipment, and light-weight construction formed the foundation for the advancement of honeycomb structures. The benefit of the honeycomb structures lies in their low weight, combined with their tremendous structural strength. Honeycomb structures are typically used as shock absorbing layers both in automobile manufacture and in sports equipment such as sports shoes owing to the anti-shock mechanical property exhibited by such structures. Honeycomb structures are apt for design and architectural applications as a result of their ratio of mass to their load carrying capacity and bend strength. Moreover, the composite material, which generally comprises a honeycomb core, can be adapted for specific requirements with regard to strength and selection of materials.

In the furniture industry, honeycomb structures are used extensively. For example, for low load bearing furniture table tops or furniture walls, 3 mm thin medium-density fiberboards (MDFs) are glued to an internal paper honeycomb core. However, in the current art of honeycomb based composites, strength failure is caused due to a lack of in-plane shear strength and tendency of the material to delaminate owing to the mixture in the material layer and structure.

Currently, a three dimensional fiber arrangement is achieved through stitching of upper and lower face sheets, or through complex knitting. Such stitching and knitting processes are cumbersome and expensive. It is cost prohibitive to use complex three dimensionally stitched or knitted composites in commonplace applications. There is a need for a faster and less costly process to achieve three dimensional fiber reinforcement, which will enable the use of three dimensional oriented fibers in commonplace composite applications in the furniture and building industry.

Hence, there is a long felt but unresolved need for a composite comprising a honeycomb structure with three dimensional fiber continuity that improves adhesion between face sheets and a core of the honeycomb structure, improves the in-plane shear strength, and reduces the risk of delamination between the core and face sheets of the honeycomb structure.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The composite disclosed herein addresses the above mentioned needs for a honeycomb structure with three dimensional fiber continuity that improves adhesion between face sheets and a core of a honeycomb structure, improves the in-plane shear strength, and reduces the risk of delamination between the core and the face sheets of the honeycomb structure.

The composite disclosed herein comprises a core comprising a cellular structure and reinforcing fibers, an upper face sheet, and a lower face sheet. The cellular structure comprises multiple cells composed of a carrier material. The cells are, for example, of a honeycomb type, with a hexagonal geometry, having a mix of shapes and cell sizes, for example, square or sinusoidal shapes. In an embodiment, the carrier material is cellulosic paper. In another embodiment, the carrier material comprises an inorganic material. The outer walls of the cells are adhered to each other to form the cellular structure. The cellular structure is a honeycomb structure comprising strips of the carrier material arranged in an x direction in an x-y plane and adhered together at alternate and spaced areas of the strips of carrier material. The honeycomb structure is formed by expanding the strips of carrier material in the x direction after the adhesion.

The reinforcing fibers are externally bonded onto the outer walls of each of the cells of the cellular structure in a z direction. In an embodiment, the reinforcing fibers comprise organic fibers of an extended length, that is, longer than the height of the outer walls of the cells of the cellular structure. In an embodiment, the reinforcing fibers comprise inorganic fibers. The inorganic fibers comprise, for example, one or more of glass fibers and carbon fibers. The reinforcing fibers conform to a shape of the cellular structure along the adhered outer walls of the cells of the cellular structure. An upper portion of the reinforcing fibers is configured to extend outwardly from the upper edges of the cells of the cellular structure. A lower portion of the reinforcing fibers is configured to extend outwardly from the lower edges of the cells of the cellular structure. In an embodiment, the length of the upper portion and the lower portion of the reinforcing fibers extending outwardly from the upper edges and the lower edges of the cells of the cellular structure respectively is greater than the width of one of the cells of the cellular structure.

The upper face sheet is configured to be bonded to the upper portion of the reinforcing fibers that extends outwardly from the upper edges of the cells of the cellular structure in the z direction. The upper portion of the reinforcing fibers that extends outwardly from the upper edges of the cells of the cellular structure in the z direction is continued in an x-y plane by the bonded upper face sheet. The lower face sheet is configured to be bonded to the lower portion of the reinforcing fibers that extends outwardly from the lower edges of the cells of the cellular structure in the z direction. The lower portion of the reinforcing fibers that extends outwardly from the lower edges of the cells of the cellular structure in the z direction is continued in the x-y plane by the bonded lower face sheet.

The upper portion and the lower portion of the reinforcing fibers extending from the upper edges and the lower edges of the cells of the cellular structure provide the following functions. Firstly, three dimensional continuity of the reinforcing fibers is established between a surface of contact between the core, the upper face sheet, and the lower face sheet. Such three dimensional continuity improves delamination resistive performance of the composite. Secondly, in some cases, it is sufficient to only coat the extending reinforcing fibers with an adhesive to bond to the upper face sheet and the lower face sheet, instead of applying adhesive to the entire upper face sheet and the lower face sheet, thereby reducing adhesive consumption.

Disclosed herein is also a second composite with a three dimensional continuity of reinforcing fibers. The second composite comprises strips of reinforcing fibers arranged in an x direction along an x-y plane and adhered together at alternate and spaced areas of the strips of reinforcing fibers. The arranged and adhered strips of reinforcing fibers are expanded in the x direction to create a honeycomb structure. The strips of reinforcing fibers are adhered to each other in a first binder matrix and substantially oriented in a z direction. An upper portion of the reinforcing fibers is configured to extend outwardly from the upper edges of the cells of the honeycomb structure in the z direction. The upper portion of the reinforcing fibers extending outwardly from the upper edges of the cells of the honeycomb structure in the z direction is configured to be set in a second binder matrix. The extended upper portion of the reinforcing fibers is continued in the x-y plane by the second binder matrix.

A lower portion of the reinforcing fibers is configured to extend outwardly from the lower edges of the cells of the honeycomb structure in the z direction. The lower portion of the reinforcing fibers extending outwardly from the lower edges of the cells of the honeycomb structure in the z direction is configured to be set in the second binder matrix. The extended lower portion of the reinforcing fibers is continued in the x-y plane by the second binder matrix. A three dimensional continuity of the reinforcing fibers is established between the first binder matrix and the second binder matrix. Hence, the second composite is created with three dimensional fiber continuity between an upper surface, a core, and a lower surface. In the above case, the upper surface is created by reinforcing fibers in the second binder matrix, the core is composed of reinforcing fibers in the first binder matrix, and the lower surface is composed of reinforcing fibers in the second binder matrix.

In an embodiment of the second composite, the upper portion of the reinforcing fibers extending outwardly from the upper edges of the cells of the honeycomb structure in the z direction is configured to be bonded to an upper face sheet and is thereby continued in the x-y plane by the bonded upper face sheet. The lower portion of the reinforcing fibers extending outwardly from the lower edges of the cells of the honeycomb structure in the z direction is configured to be bonded to a lower face sheet and is thereby continued in the x-y plane by the bonded lower face sheet.

Disclosed herein is also a method for manufacturing a composite with a three dimensional continuity of reinforcing fibers. Sheets of reinforcing fibers, an adhesive, a first fiber binder resin, and a second fiber binder resin are provided. The first fiber binder resin and the second fiber binder resin comprise, for example, epoxy, polyester resins such as orthothalic polyester resin, polyurethanes, vinyl esters, phenolic resins, urea formaldehyde, etc. Each of the sheets of reinforcing fibers is coated with the first fiber binder resin along multiple selected linear paths to create multiple coated areas and non-coated areas on the sheets of reinforcing fibers. The coated areas on the sheets of reinforcing fibers constitute a first binder matrix. Examples of methods of resin coating on the sheets of reinforcing fibers are, for example, roller coating, spray on systems, etc. The adhesive is applied on equally spaced areas along a length of the coated areas of each of the sheets of reinforcing fibers after allowing the sheets of reinforcing fibers to cure. Each of the sheets of reinforcing fibers are arranged, one on top of another to form a bundle of sheets of reinforcing fibers.

The bundle of sheets of reinforcing fibers is sliced from an upper surface to a lower surface of the bundle of sheets of reinforcing fibers along a line passing through the non-coated areas on the sheets of reinforcing fibers to form separate strips of reinforcing fibers. Each of the strips of reinforcing fibers is expanded in an x direction in an x-y plane to create a honeycomb structure. The created honeycomb structure comprises reinforcing fibers oriented in a z direction in the first binder matrix. An upper portion and a lower portion of the reinforcing fibers extend outwardly from the upper edges and the lower edges of the cells of the honeycomb structure. The upper portion and the lower portion of the reinforcing fibers extending outwardly from the upper edges and the lower edges of the cells of the honeycomb structure respectively are flattened along the x-y plane.

The flattened upper portion and lower portion of the reinforcing fibers extending outwardly from the upper edges and the lower edges of the cells of the honeycomb structure respectively are wetted along the x-y plane using the second fiber binder resin to form a second binder matrix, thereby establishing a three dimensional fiber continuity of the reinforcing fibers between the first binder matrix and the second binder matrix, after curing of the composite. In an embodiment, the method for manufacturing the composite with a three dimensional continuity of reinforcing fibers comprises orienting and adhering additional reinforcing fibers in a direction perpendicular to the z direction, to the strips of reinforcing fibers oriented in the z direction. The strips of reinforcing fibers oriented in the z direction are high density reinforcing fibers and the adhered additional reinforcing fibers oriented perpendicular to the strips of reinforcing fibers oriented in the z direction are low density reinforcing fibers. The number and the density of the additional reinforcing fibers are less than the number and the density of the reinforcing fibers oriented in the z direction respectively.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein.

FIG. 1A exemplarily illustrates a top plan view showing strips of reinforcing fibers sandwiched between strips of a carrier material.

FIG. 1B exemplarily illustrates a top plan view showing a cellular structure formed by expanding the strips of reinforcing fibers sandwiched between the strips of the carrier material.

FIG. 2 exemplarily illustrates an exploded view of a composite, showing a core comprising the cellular structure and the reinforcing fibers, and an upper face sheet, and a lower face sheet.

FIG. 3A exemplarily illustrates an isometric view of the composite, showing the core with the reinforcing fibers externally bonded onto the outer walls of each of the cells of the cellular structure, sandwiched between the upper face sheet and the lower face sheet.

FIG. 3B exemplarily illustrates a front elevation view of the composite shown in FIG. 3A.

FIG. 3C exemplarily illustrates a sectional view of the composite of FIG. 3B, taken along a section A-A, showing a three dimensional continuity of reinforcing fibers established between a surface of contact between the core, the upper face sheet, and the lower face sheet of the composite.

FIG. 4A exemplarily illustrates a top plan view of an embodiment of the composite, showing strips of reinforcing fibers arranged in an x direction along an x-y plane and adhered together at alternate and spaced areas of the strips of the reinforcing fibers.

FIG. 4B exemplarily illustrates a top plan view of the embodiment of the composite, showing the reinforcing fibers expanded in the x direction to create a honeycomb structure.

FIG. 5 exemplarily illustrates an isometric view of the embodiment of the composite, showing the reinforcing fibers adhered to each other in a first binder matrix after the expansion of the reinforcing fibers along the x direction to create the honeycomb structure.

FIG. 6 exemplarily illustrates a front elevation view of the honeycomb structure after application of an adhesive resin on the upper surface and the lower surface of the honeycomb structure to form a second binder matrix between the upper surface and the lower surface of the honeycomb structure.

FIGS. 7A-7B exemplarily illustrate a method for manufacturing a composite with a three dimensional continuity of reinforcing fibers.

FIG. 8A exemplarily illustrates an isometric view of an embodiment of the honeycomb structure with reinforcing fibers oriented along a z direction and additional reinforcing fibers oriented perpendicular to the z direction.

FIG. 8B exemplarily illustrates an enlarged view of a single cell of the honeycomb structure shown in FIG. 8A, with reinforcing fibers oriented along a z direction and additional reinforcing fibers oriented perpendicular to the z direction.

### DETAILED DESCRIPTION OF THE INVENTION

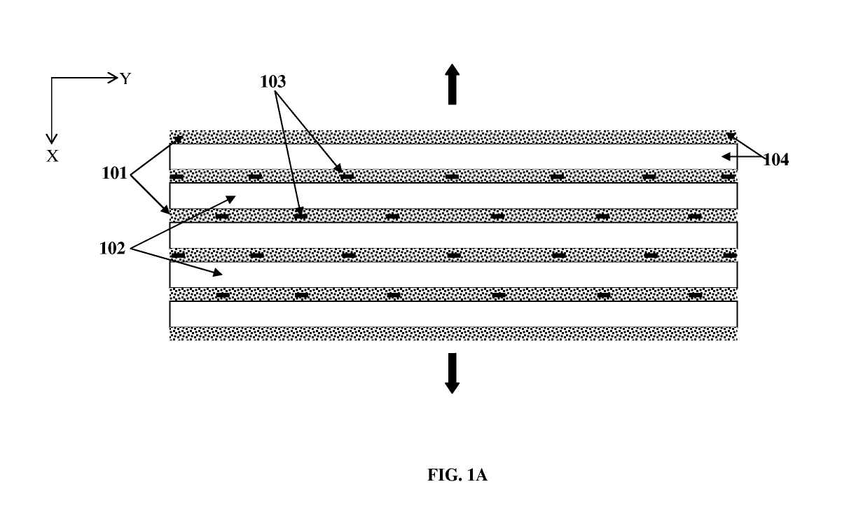

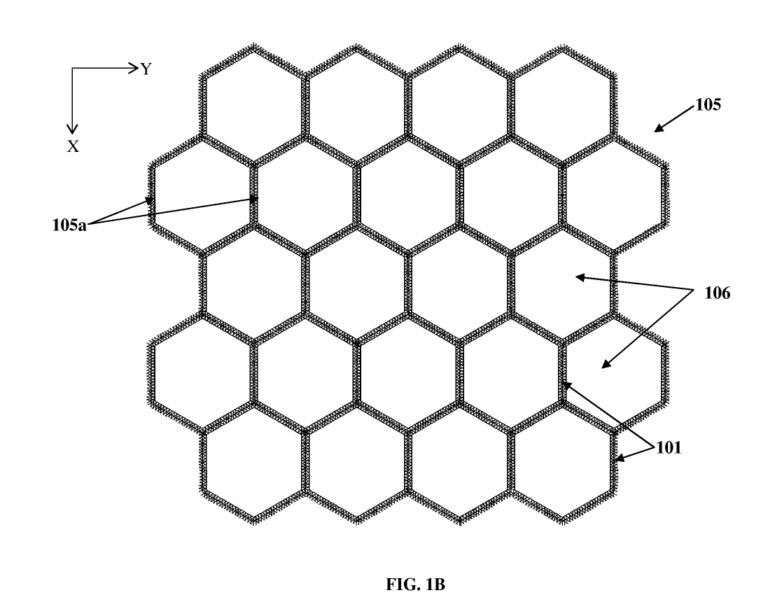

FIG. 1A exemplarily illustrates a top plan view, showing strips of reinforcing fibers 101 sandwiched between strips of a carrier material 102. Strips of a carrier material 102 with bonded strips of reinforcing fibers 101 are arranged in an x direction in an x-y plane and adhered together at alternate and spaced areas 103 of the strips of carrier material 102 as exemplarily illustrated in FIG. 1A. In an embodiment, the carrier material 102 is cellulosic paper. In another embodiment, the carrier material 102 comprises an inorganic material, for example, Aramid paper. In an embodiment, the reinforcing fibers 101 comprise organic fibers of an extended length. The organic fibers are, for example, cotton fibers or thread, long jute fibers, long coconut fibers, long kenaf fibers, etc. In another embodiment, the reinforcing fibers 101 comprise inorganic fibers. The inorganic fibers comprise, for example, one or more of glass fibers and carbon fibers. The strips of reinforcing fibers 101 are sandwiched between the strips of carrier material 102 along the x direction to form a dual layer 104. In such a sandwiched structure, the stiffness and compressive strength of the entire sandwiched structure is greater than the additive stiffness and compressive strength of the individual elements of the composite 100a, that is, of the individual carrier material 102 and the individual reinforcing fibers 101. In an example, an adhesive resin is applied at alternate and spaced areas 103 between the surfaces of contact between corresponding dual layers 104 for adhering the dual layers 104.

FIG. 1B exemplarily illustrates a top plan view, showing a cellular structure 105 formed by expanding the strips of reinforcing fibers 101 sandwiched between the strips of the carrier material 102. The cellular structure 105 is formed by expanding the strips of carrier material 102 with the bonded strips of reinforcing fibers 101 in the x direction after adhesion as exemplarily illustrated in FIG. 1B. The cellular structure 105 comprises multiple cells 106 composed of a carrier material 102. The outer walls 105a of the cells 106 are adhered to each other to form the cellular structure 105. The reinforcing fibers 101 are externally bonded onto the outer walls 105a of each of the cells 106 of the cellular structure 105 in a z direction. The reinforcing fibers 101 conform to a shape of the cellular structure 105 along the adhered outer walls 105a of the cells 106 of the cellular structure 105. The cellular structure 105 is a honeycomb structure comprising the strips of carrier material 102 arranged in the x direction in the x-y plane and adhered together at alternate and spaced areas 103 of the strips of carrier material 102. A tensile force is applied along the x direction to expand the strips of carrier material 102. The honeycomb structure is formed by expanding the strips of carrier material 102 in the x direction after the adhesion.

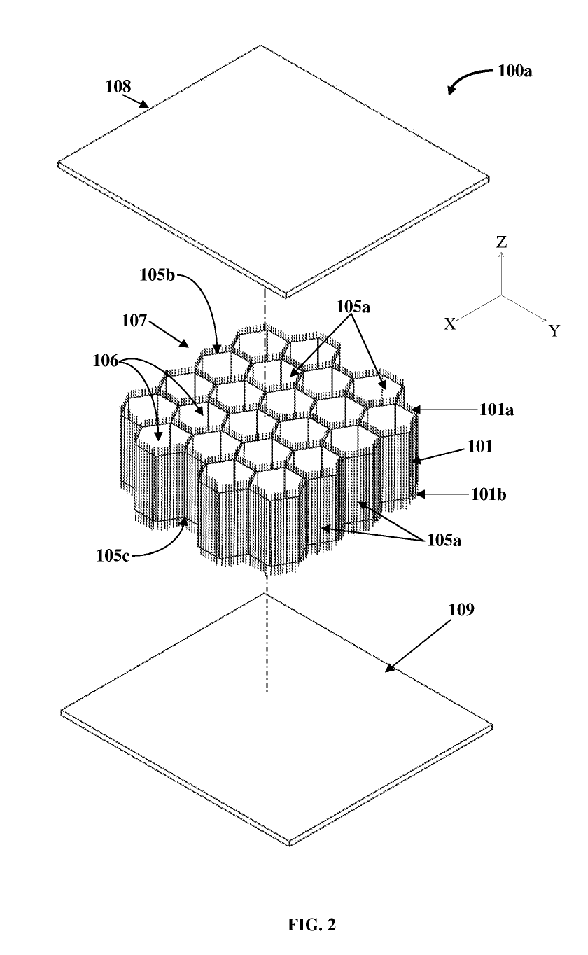

FIG. 2 exemplarily illustrates an exploded view of a composite 100a, showing a core 107 comprising the cellular structure 105 and the reinforcing fibers 101, and an upper face sheet 108, and a lower face sheet 109. The core 107 comprises the cellular structure 105 and the reinforcing fibers 101 externally bonded onto the outer walls 105a of each of the cells 106 of the cellular structure 105 in a z direction. An upper portion 101a of the reinforcing fibers 101 is configured to extend outwardly from upper edges 105b of the cells 106 of the cellular structure 105. A lower portion 101b of the reinforcing fibers 101 is configured to extend outwardly from the lower edges 105c of the cells 106 of the cellular structure 105. In an embodiment, the length of the upper portion 101a and the lower portion 101b of the reinforcing fibers 101 extending from the upper edges 105b and the lower edges 105c of the cells 106 of the cellular structure 105 respectively is greater than the width of an individual cell 106 of the cellular structure 105.

The upper face sheet 108 is configured to be bonded to the upper portion 101a of the reinforcing fibers 101 that extend outwardly from the upper edges 105b of the cells 106 of the cellular structure 105 in the z direction. The upper portion 101a of the reinforcing fibers 101 extending outwardly from the upper edges 105b of the cells 106 of the cellular structure 105 in the z direction is continued in an x-y plane by the bonded upper face sheet 108. The lower face sheet 109 is configured to be bonded to the lower portion 101b of the reinforcing fibers 101 extending outwardly from the lower edges 105c of the cells 106 of the cellular structure 105 in the z direction. The lower portion 101b of the reinforcing fibers 101 extending outwardly from the lower edges 105c of the cells 106 of the cellular structure 105 in the z direction is continued in the x-y plane by the bonded lower face sheet 109. A three dimensional continuity of the reinforcing fibers 101 is established between a surface of contact between the core 107, the upper face sheet 108, and the lower face sheet 109.

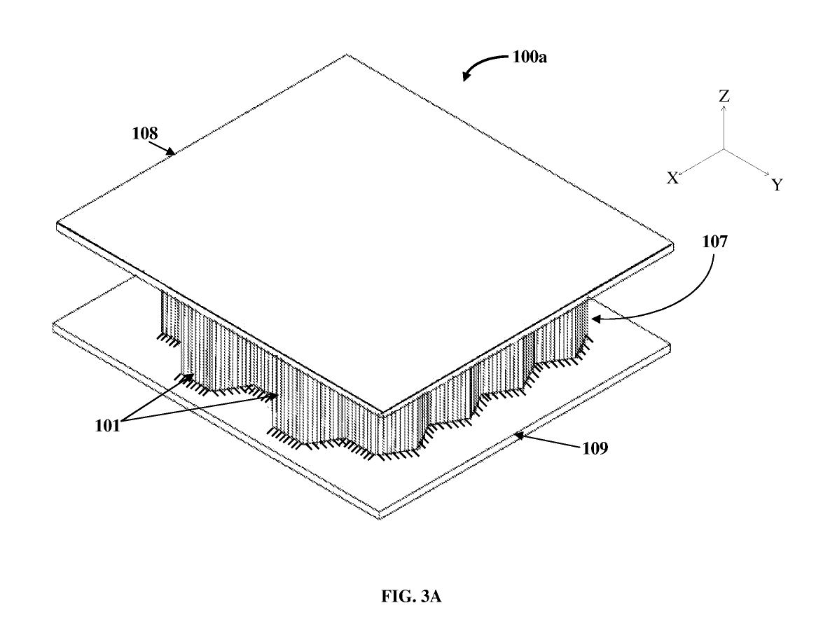

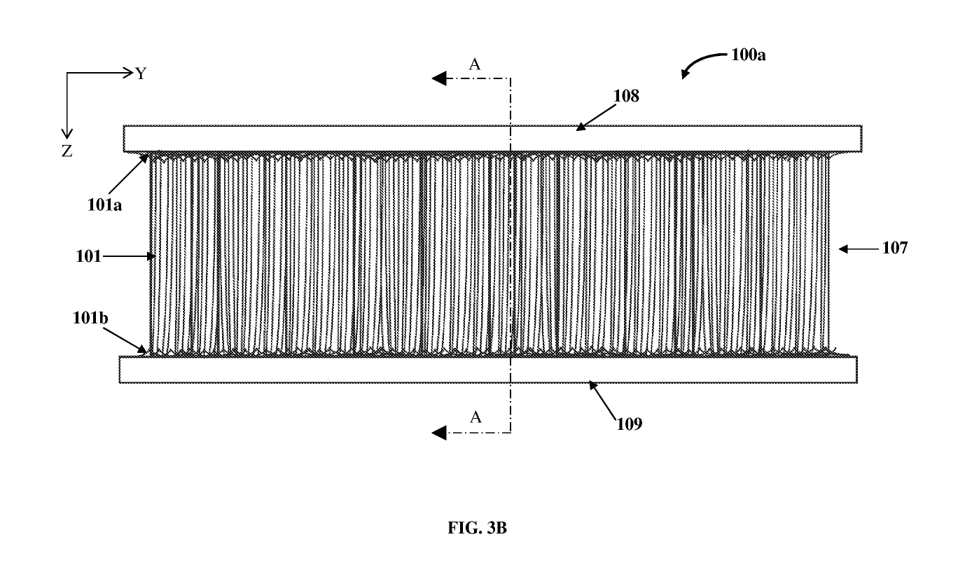

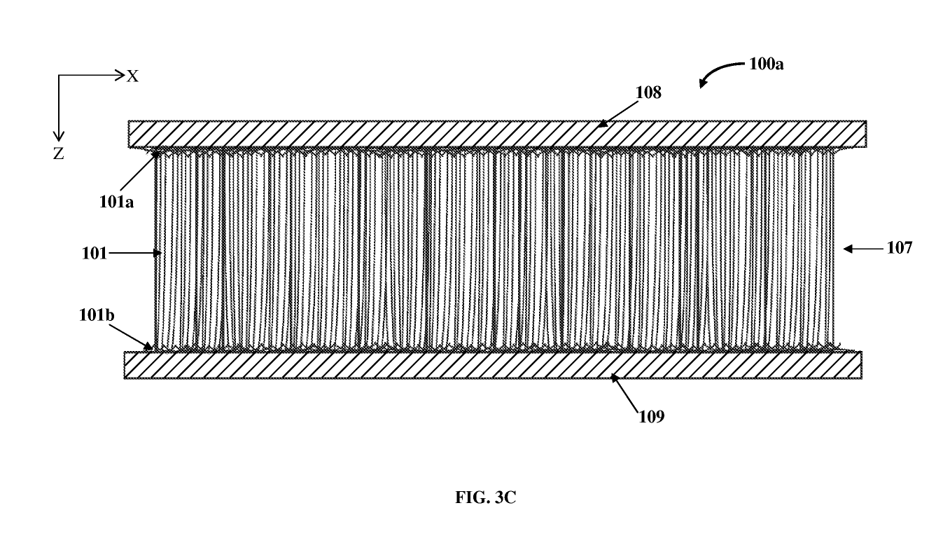

FIG. 3A exemplarily illustrates an isometric view of the composite 100a, showing the core 107 with the reinforcing fibers 101 externally bonded onto the outer walls 105a of each of the cells 106 of the cellular structure 105, sandwiched between the upper face sheet 108 and the lower face sheet 109. FIG. 3B exemplarily illustrates a front elevation view of the composite 100a shown in FIG. 3A. The bonded upper face sheet 108 makes the upper portion 101a of the reinforcing fibers 101 that extend outwardly from the upper edges 105b of the cells 106 of the cellular structure 105 in a substantially vertical direction to be continued in a horizontal plane on the upper edges 105b of the cells 106 of the cellular structure 105. The bonded lower face sheet 109 makes the lower portion 101b of the reinforcing fibers 101 that extend outwardly from the lower edges 105c of the cells 106 of the cellular structure 105 in a substantially vertical direction to be coninued in a horizontal plane on the lower edges 105c of the cells 106 of the cellular structure 105.

FIG. 3C exemplarily illustrates a sectional view of the composite 100a of FIG. 3B, taken along a section A-A, showing the three dimensional continuity of reinforcing fibers 101 established between a surface of contact between the core 107, the upper face sheet 108, and the lower face sheet 109 of the composite 100a. The three dimensional continuity of the reinforcing fibers 101 is established when the reinforcing fibers 101 are oriented along the z axis and the upper portion 101a and lower portion 101b of the reinforcing fibers 101 are oriented along multiple directions in the x-y plane at the upper edges 105b and the lower edges 105c of the cells 106 of the cellular structure 105 respectively.

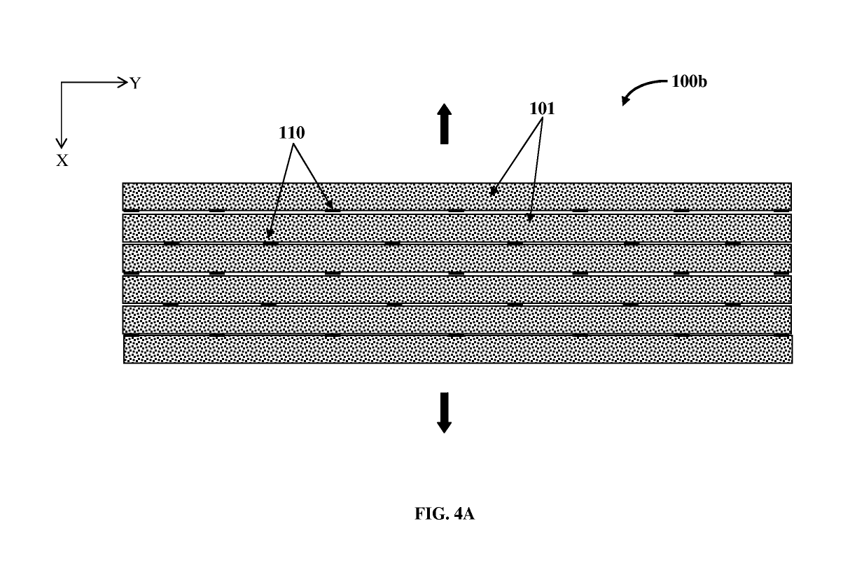

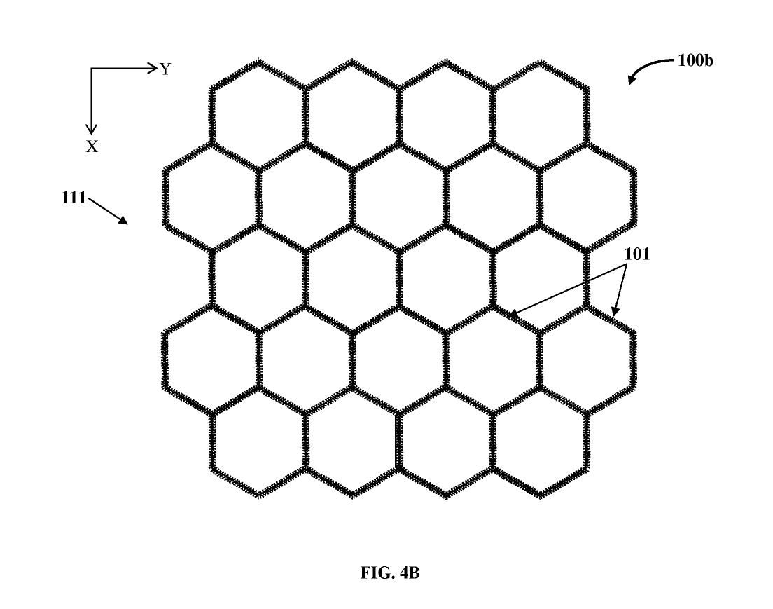

FIG. 4A exemplarily illustrates a top plan view of an embodiment of a composite 100b, showing strips of reinforcing fibers 101 arranged in an x direction along an x-y plane and adhered together at alternate and spaced areas 110 of the strips of reinforcing fibers 101. The composite 100b disclosed herein has a three dimensional continuity of reinforcing fibers 101. The composite 100b disclosed herein comprises strips of reinforcing fibers 101 arranged in an x direction along an x-y plane and adhered together at alternate and spaced areas 110 of the strips of the reinforcing fibers 101.

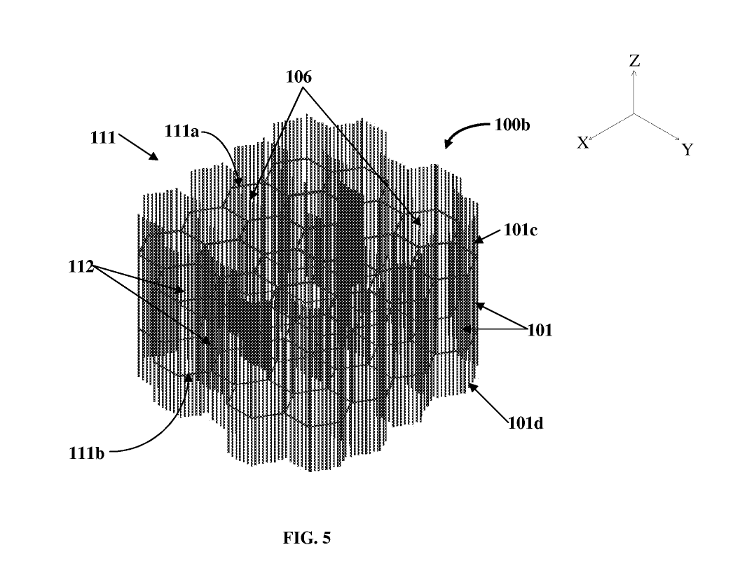

FIG. 4B exemplarily illustrates a top plan view of the embodiment of the composite 100b, showing the reinforcing fibers 101 expanded in the x direction to create a honeycomb structure 111. The arranged and adhered strips of the reinforcing fibers 101 are expanded in the x direction to create a honeycomb structure 111. The strips of reinforcing fibers 101 are adhered to each other in a first binder matrix 112 and substantially oriented in a z direction as exemplarily illustrated in FIG. 5.

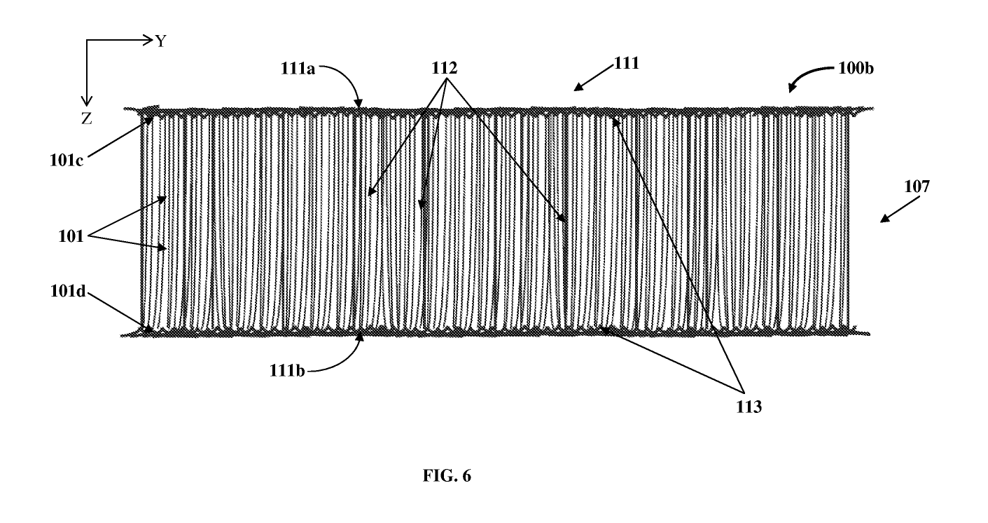

FIG. 5 exemplarily illustrates an isometric view of the embodiment of the composite 100b, showing the reinforcing fibers 101 adhered to each other in a first binder matrix 112 after the expansion of the reinforcing fibers 101 along the x direction to create the honeycomb structure 111. An upper portion 101c of the reinforcing fibers 101 is configured to extend outwardly from the upper edges 111a of the cells 106 of the honeycomb structure 111 in a z direction. The upper portion 101c of the reinforcing fibers 101 that extends outwardly from the upper edges 111a of the cells 106 of the honeycomb structure 111 in the z direction is configured to be set in a second binder matrix 113 as exemplarily illustrated in FIG. 6. The extended upper portion 101c of the reinforcing fibers 101 is continued in the x-y plane by the second binder matrix 113. The first binder matrix 112 and the second binder matrix 113 is an adhesive resin, for example, polyester, epoxy, vinyl esters, phenolic, polyurethane, urea formaldehyde, etc.

The methods of resin coating over the reinforcing fibers 101 are, for example, roller coating, spray on systems, etc.

A lower portion 101d of the reinforcing fibers 101 is configured to extend outwardly from the lower edges 111b of the cells 106 of the honeycomb structure 111 in the z direction. The lower portion 101d of the reinforcing fibers 101 extending outwardly from the lower edges 111b of the cells 106 of the honeycomb structure 111 in the z direction is configured to be set in the second binder matrix 113. The extended lower portion 101d of the reinforcing fibers 101 is continued in the x-y plane by the second binder matrix 113. A three dimensional continuity of the reinforcing fibers 101 is therefore established between the first binder matrix 112 and the second binder matrix 113.

FIG. 6 exemplarily illustrates a front elevation view of the honeycomb structure 111 after application of an adhesive resin on the upper surface and the lower surface of the honeycomb structure 111, that is, after the application of a second binder matrix 113 between the upper surface and the lower surface of the honeycomb structure 111. The upper edges 111a of each of the cells 106 of the honeycomb structure 111 constitute the upper surface of the honeycomb structure 111. The lower edges 111b of each of the cells 106 of the honeycomb structure 111 constitute the lower surface of the honeycomb structure 111. When a resin is applied on the upper surface and the lower surface of the honeycomb structure 111, the upper portion 101c of the reinforcing fibers 101 that extends outwardly from the upper surface of the honeycomb structure 111 is bent along a horizontal direction on the upper surface of the honeycomb structure 111, and the lower portion 101d of the reinforcing fibers 101 that extends outwardly from the lower surface of the honeycomb structure 111 is bent along the horizontal direction on the lower surface of the honeycomb structure 111.

In an embodiment, the upper portion 101c of the reinforcing fibers 101 extending outwardly from the upper edges 111a of the cells 106 of the honeycomb structure 111 in the z direction is configured to be bonded to an upper face sheet 108. The extended upper portion 101c of the reinforcing fibers 101 is continued in the x-y plane on the upper surface of the honeycomb structure 111 by the bonded upper face sheet 108. The lower portion 101d of the reinforcing fibers 101 extending outwardly from the lower edges 111b of the cells 106 of the honeycomb structure 111 in the z direction is configured to be bonded to a lower face sheet 109. The extended lower portion 101d of the reinforcing fibers 101 is continued in the x-y plane on the lower surface of the honeycomb structure 111 by the bonded lower face sheet 109.

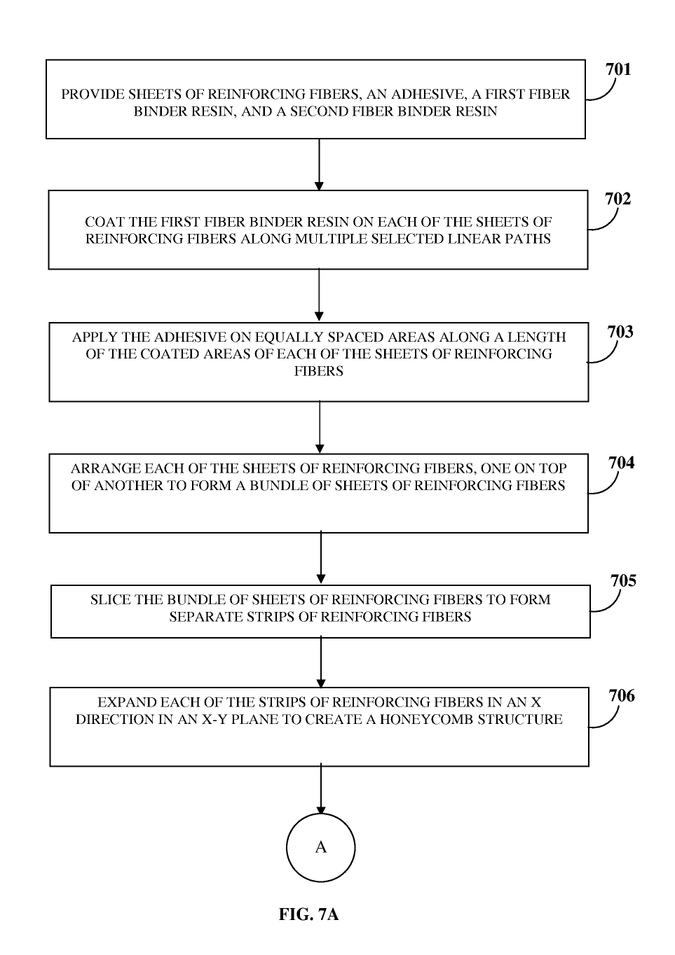

FIGS. 7A-7B exemplarily illustrate a method for manufacturing a composite 100b shown in FIG. 5, with a three dimensional continuity of reinforcing fibers 101. Sheets of reinforcing fibers 101, an adhesive, a first fiber binder resin, and a second fiber binder resin are provided 701. The first fiber binder resin is coated 702 on each of the sheets of reinforcing fibers 101 along multiple selected linear paths to create multiple coated areas and multiple non-coated areas on the sheets of reinforcing fibers 101. The coated areas of the sheets of reinforcing fibers 101 constitute a first binder matrix 112. The adhesive is applied 703 on equally spaced areas 110 along a length of the coated areas of each of the sheets of reinforcing fibers 101 after allowing the sheets of reinforcing fibers 101 to cure. Each of the sheets of reinforcing fibers 101 is arranged 704, one on top of another, to form a bundle of sheets of reinforcing fibers 101.

The bundle of sheets of reinforcing fibers 101 is sliced 705 from an upper surface to a lower surface of the bundle of sheets of reinforcing fibers 101 along a line passing through the non-coated areas on the sheets of reinforcing fibers 101 to form separate strips of reinforcing fibers 101. Each of the strips of reinforcing fibers 101 is expanded 706 in an x direction in an x-y plane to create a honeycomb structure 111 comprising the reinforcing fibers 101 oriented in a z direction in the first binder matrix 112. The upper portion 101c and the lower portion 101d of the reinforcing fibers 101 extend outwardly from the upper edges 111a and the lower edges 111b of the cells 106 of the honeycomb structure 111. The upper portion 101c and the lower portion 101d of the reinforcing fibers 101 extending outwardly from the upper edges 111a and the lower edges 111b of the cells 106 of the honeycomb structure 111 respectively, are flattened 707 along the x-y plane. The flattened upper portion 101c and lower portion 101d of the reinforcing fibers 101 extending outwardly from the upper edges 111a and the lower edges 111b of the cells 106 of the honeycomb structure 111 respectively are wetted 708 along the x-y plane using the second fiber binder resin to form a second binder matrix 113, thereby establishing 709 a three dimensional fiber continuity of reinforcing fibers 101 between the first binder matrix 112, the core 107 exemplarily illustrated in FIG. 6, and the second binder matrix 113 after curing of the composite 100b.

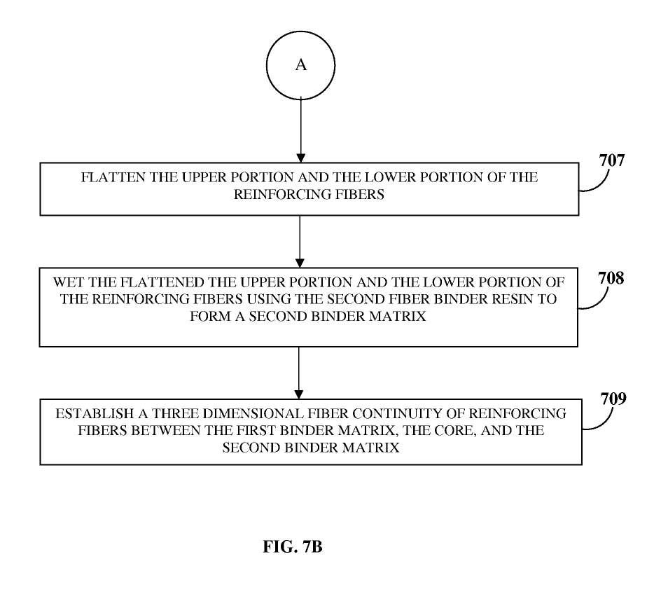

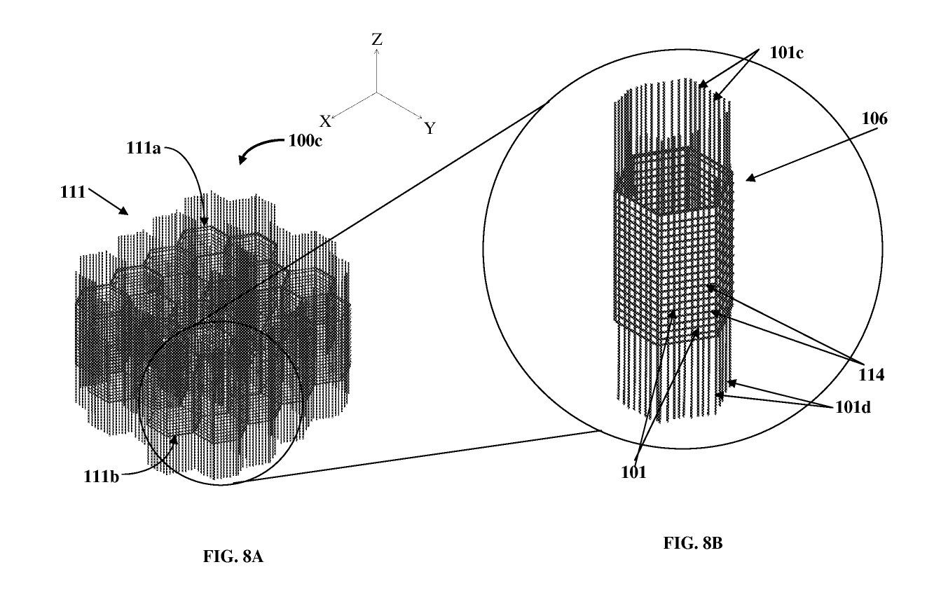

FIG. 8A exemplarily illustrates an isometric view of an embodiment of the honeycomb structure 111 with reinforcing fibers 101 oriented along a z direction and additional reinforcing fibers 114 oriented perpendicular to the z direction. FIG. 8B exemplarily illustrates an enlarged view of a single cell 106 of the honeycomb structure 111 shown in FIG. 8A, with reinforcing fibers 101 oriented along the z direction and additional reinforcing fibers 114 oriented perpendicular to the z direction. In this embodiment, the method for manufacturing the composite 100c with a three dimensional continuity of reinforcing fibers 101 comprises orienting additional reinforcing fibers 114 in a direction perpendicular to the z direction, and adhering the oriented additional reinforcing fibers 114 to the strips of reinforcing fibers 101 oriented in the z direction. The strips of reinforcing fibers 101 oriented in the z direction are high density reinforcing fibers 101 and the additional reinforcing fibers 114 oriented perpendicular to the strips of reinforcing fibers 101 oriented in the z direction are low density reinforcing fibers 114. The number and the density of the additional reinforcing fibers 114 are less than the number and the density of the reinforcing fibers 101 oriented in the z direction respectively.

Example 1: A sheet of reinforcing fibers 101, for example, organic jute fibers, oriented substantially in the z direction is placed on a planar surface. Narrow strips of Kraft paper 1 inch wide are cut and adhered to both sides of the sheet of reinforcing fibers 101. These strips of Kraft paper are positioned parallel to one another, with a spacing of two inches between them. Adhesives are applied every three inches along the paper strips. The sheet of reinforcing fibers 101 with adhered strips of Kraft paper are placed one above the another, staggered lengthwise by 1.5 inches. After the adhesive cures, the above bundle of sheets of reinforcing fibers 101 are further cut into stacked strips of reinforcing fibers 101 by making a cut along the center of the two inch gap between the paper strips. Each of the stacked strips of reinforcing fibers 101 are expanded to create a honeycomb structure 111, wherein loose fibers extend out of the upper edges 111a and the lower edges 111b of the cells 106 of the honeycomb structure 111. The loose extending reinforcing fibers 101 are then coated with an adhesive and thereafter attached to a 3 mm thick top and 3 mm thick bottom medium density fiberboard (MDF) sheet. A 24% increase in modulus of rupture (MOR) performance was achieved with the above three dimensional fiber arrangement, when compared to the case without the use of reinforcing fibers 101.

Example 2: A sheet of reinforcing fibers 101, for example, woven glass fibers of 450 grams per square meter weight is positioned on a roller. The sheet of reinforcing fibers 101 is sent through a roll coater, where orthothalic polyester resin is coated along 1 inch strips on the sheet, with three inches spacing between the coated strips. Hence, on the glass fiber sheet, 3 inch bands of uncoated glass fibers are followed by 1 inch polyester coated glass fibers. After the polyester resin cures, epoxy adhesive is applied every three inches along the polyester coated glass fiber area. In the above manner, ten feet long, and four feet wide sheets of glass fibers, with epoxy strips alternatively located, are placed one above the other, and pressed using a ten ton press. After the epoxy cures, a cut is made along the center line of the uncoated 3 inch wide glass fiber area. Hence, multiple stacks of strips of reinforcing fibers 101 are created, and each stack unit is expanded in the x direction to create a honeycomb structure 111 with an uncoated sheet of reinforcing fibers 101 extending out of the coated polyester walls of the honeycomb structure 111 in the z direction. The extending uncoated sheet of reinforcing fibers 101 on the upper surface of the honeycomb structure 111 is then wetted with a polyester resin and flattened out as the upper surface of the honey comb structure 111. Similarly, the extending uncoated reinforcing fibers 101 on the lower surface of the honeycomb structure 111 is then wetted with a polyester resin and flattened out as the lower surface. In this example, the reinforcing fibers 101 are flattened out in the above mentioned x direction. The flattening process is carried out by pressing two Teflon® coated sheets onto the upper surface and the lower surface of the honeycomb structure 111. In the above example, a sheet of reinforcing fibers 101, for example, a specially woven glass sheet with greater density reinforcing fibers extending in one direction and lower density reinforcing fibers 114 extending in a corresponding perpendicular direction exemplarily illustrated in FIG. 8B are used. The direction of the greater density sheet of reinforcing fibers 101 is oriented along the z direction.

The composites 100a, 100b, and 100c, exemplarily illustrated in FIG. 3A, FIG. 5, and FIG. 8A respectively, can be used as a substitute for plywood, solid wood, particleboard, etc. The composites 100a, 100b, and 100c can be used as a structural component in building structures that provides enhanced stiffness.

The foregoing examples have been provided merely for the purpose of explanation and are in no way to be construed as limiting of the invention disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

I claim:

1. A composite comprising:
a core comprising:
a cellular structure comprising a plurality of cells composed of a carrier material, wherein outer walls of said cells are adhered to each other to define said cellular structure; and
reinforcing fibers externally bonded onto said outer walls of each of said cells of said cellular structure in a z direction, wherein said reinforcing fibers conform to a shape of said cellular structure along said adhered outer walls of said cells of said cellular structure, and wherein an upper portion of said reinforcing fibers is configured to extend outwardly from upper edges of said cells of said cellular structure, and wherein a lower portion of said reinforcing fibers is configured to extend outwardly from lower edges of said cells of said cellular structure;
an upper face sheet configured to be bonded to said upper portion of said reinforcing fibers extending outwardly from said upper edges of said cells of said cellular structure in said z direction, wherein said upper portion of said reinforcing fibers extending outwardly from said upper edges of said cells of said cellular structure in said z direction is continued in an x-y plane by said bonded upper face sheet; and
a lower face sheet configured to be bonded to said lower portion of said reinforcing fibers extending outwardly from said lower edges of said cells of said cellular structure in said z direction, wherein said lower portion of said reinforcing fibers extending outwardly from said lower edges of said cells of said cellular structure in said z direction is continued in said x-y plane by said bonded lower face sheet;
whereby a three dimensional continuity of said reinforcing fibers is established between a surface of contact between said core, said upper face sheet, and said lower face sheet;

2. The composite of claim 1, wherein said cellular structure is a honeycomb structure comprising strips of said carrier material arranged in an x direction in said x-y plane and adhered together at alternate and spaced areas of said strips of said carrier material, wherein said honeycomb structure is formed by expanding said strips of said carrier material in said x direction after said adhesion.

3. The composite of claim 1, wherein said reinforcing fibers comprise organic fibers of an extended length.

4. The composite of claim 1, wherein said reinforcing fibers comprise inorganic fibers.

5. The composite of claim 4, wherein said inorganic fibers comprise one or more of glass fibers and carbon fibers.

6. The composite of claim 1, wherein said carrier material is cellulosic paper.

7. The composite of claim 1, wherein said carrier material comprises an inorganic material.

8. The composite of claim 1, wherein a length of said upper portion and said lower portion of said reinforcing fibers extending outwardly from said upper edges and said lower edges of said cells of said cellular structure respectively, is greater than a width of one of said cells of said cellular structure.

9. A composite with a three dimensional continuity of reinforcing fibers, comprising:
strips of said reinforcing fibers arranged in an x direction along an x-y plane and adhered together at alternate and spaced areas of said strips of said reinforcing fibers, wherein said arranged and adhered strips of said reinforcing fibers are expanded in said x direction to create a honeycomb structure, and wherein said strips of said reinforcing fibers are adhered to each other in a first binder matrix and substantially oriented in a z direction;
an upper portion of said reinforcing fibers configured to extend outwardly from upper edges of cells of said honeycomb structure in a z direction, wherein said upper portion of said reinforcing fibers extending outwardly from said upper edges of said cells of said honeycomb structure in said z direction is configured to be set in a second binder matrix, and wherein said extended upper portion of said reinforcing fibers is continued in said x-y plane by said second binder matrix; and
a lower portion of said reinforcing fibers configured to extend outwardly from lower edges of said cells of said honeycomb structure in said z direction, wherein said lower portion of said reinforcing fibers extending outwardly from said lower edges of said cells of said honeycomb structure in said z direction is configured to be set in said second binder matrix, and wherein said extended lower portion of said reinforcing fibers is continued in said x-y plane by said second binder matrix;
whereby said three dimensional continuity of said reinforcing fibers is established between said first binder matrix and said second binder matrix.

10. The composite of claim 9, wherein said upper portion of said reinforcing fibers extending outwardly from said upper edges of said cells of said honeycomb structure in said z direction is configured to be bonded to an upper face sheet, and wherein said upper portion of said reinforcing fibers extending outwardly from said upper edges of said cells of said honeycomb structure in said z direction is continued in said x-y plane by said bonded upper face sheet.

11. The composite of claim 9, wherein said lower portion of said reinforcing fibers extending outwardly from said lower edges of said cells of said honeycomb structure in said z direction is configured to be bonded to a lower face sheet, and wherein said lower portion of said reinforcing fibers extending outwardly from said lower edges of said cells of said honeycomb structure in said z direction is continued in said x-y plane by said bonded lower face sheet.

12. A method for manufacturing a composite with a three dimensional continuity of reinforcing fibers, comprising:
providing sheets of reinforcing fibers, an adhesive, and a first fiber binder resin, and a second fiber binder resin;
coating said first fiber binder resin on each of said sheets of said reinforcing fibers along a plurality of selected linear paths to create a plurality of coated areas and non-coated areas on said sheets of said reinforcing fibers, wherein said coated areas on said sheets of said reinforcing fibers constitute a first binder matrix;
applying said adhesive on equally spaced areas along a length of said coated areas of said each of said sheets of said reinforcing fibers after allowing said sheets of said reinforcing fibers to cure;
arranging said each of said sheets of said reinforcing fibers, one on top of another to form a bundle of said sheets of said reinforcing fibers;
slicing said bundle of said sheets of said reinforcing fibers from an upper surface to a lower surface of said bundle of said sheets of said reinforcing fibers along a line passing through said non-coated areas on said sheets of said reinforcing fibers to form separate strips of said reinforcing fibers;
expanding each of said strips of said reinforcing fibers in an x direction in an x-y plane to create a honeycomb structure comprising said reinforcing fibers oriented in a z direction in said first binder matrix, wherein an upper portion and a lower portion of said reinforcing fibers extend outwardly from upper edges and lower edges of cells of said honeycomb structure;
flattening said upper portion and said lower portion of said reinforcing fibers extending outwardly from said upper edges and said lower edges of said cells of said honeycomb structure respectively, along said x-y plane;
wetting said flattened said upper portion and said lower portion of said reinforcing fibers extending outwardly from said upper edges and said lower edges of said honeycomb structure respectively, along said x-y plane using said second fiber binder resin to form a second binder matrix; and
establishing a three dimensional fiber continuity of said reinforcing fibers between said first binder matrix and said second binder matrix after curing of said composite.

13. The method of claim 12, further comprising orienting and adhering additional reinforcing fibers in a direction perpendicular to said z direction, to said strips of said reinforcing fibers oriented in said z direction, wherein number and density of said additional reinforcing fibers are less than number and density of said reinforcing fibers oriented in said z direction respectively.

14. The method of claim 13, wherein said strips of said reinforcing fibers oriented in said z direction are high density reinforcing fibers and said adhered additional reinforcing fibers oriented perpendicular to said strips of said reinforcing fibers oriented in said z direction are low density reinforcing fibers.
